(19) United States
(12) Patent Application Publication
(10) Pub. No.: US 2024/0402980 A1
(43) Pub. Date: Dec. 5, 2024

(54) DISABLING AUDIO CODING OF MEDIA CONTENT WHEN A NO VOLUME CONDITION OF A DEVICE IS DETECTED

(71) Applicant: QUALCOMM Incorporated, San Diego, CA (US)

(72) Inventors: Aman DEEP, Hyderabad (IN); Ramya Jyothi THALLAM, Hyderabad (IN); Sudha Rani VATTE, Miryalaguda (IN); Jayapal ARURI, Hyderabad (IN)

(21) Appl. No.: 18/325,467

(22) Filed: May 30, 2023

(51) Int. Cl. G06F 3/16; H04N 21/43; H04N 21/434

(52) U.S. Cl. CPC G06F 3/165; H04N 21/4307; H04N 21/4341

(57) ABSTRACT

A device includes one or more processors configured to obtain a media stream that includes at least one audio stream. The one or more processors are also configured to disable audio coding of the at least one audio stream based on a no volume condition associated with the at least one audio stream.

### I. FIELD

The present disclosure is generally related to disabling audio coding of media content when a no volume condition of a device is detected.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to record and play media content that includes audio content, video content, or both. During recording or playback of media content, computing devices process one or more audio streams of the media content via audio coding (i.e., audio encoding when recording and audio decoding during playback of media content). A complaint associated with battery powered devices is that an amount of time that the battery powered devices can be used before needing to be recharged is too short. It is desirable to limit the processing of audio content to limit power usage by the computing devices. For battery powered devices, limiting the processing of audio content can extend a number of hours of use of the battery powered devices before the batteries of the battery powered devices needs to be recharged.

### III. SUMMARY

According to one implementation of the present disclosure, a device includes one or more processors configured to obtain a media stream that includes at least one audio stream. The one or more processors are also configured to disable audio coding of the at least one audio stream based on a no volume condition associated with the at least one audio stream.

According to another implementation of the present disclosure, a method includes obtaining, at one or more processors, a media stream that includes at least one audio stream. The method also includes disabling, via the one or more processors, audio coding of the at least one audio stream based on a no volume condition associated with the at least one audio stream.

According to another implementation of the present disclosure, a non-transitory computer-readable medium includes instructions that, when executed by one or more processors, cause the one or more processors to obtain a media stream that includes at least one audio stream. The instructions, when executed by one or more processors, also cause the one or more processors to disable audio coding of the at least one audio stream based on a no volume condition associated with the at least one audio stream.

According to another implementation of the present disclosure, an apparatus includes means for obtaining a media stream that includes at least one audio stream. The apparatus also includes means for disabling audio coding of the at least one audio stream based on a no volume condition associated with the at least one audio stream.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to disable audio coding of at least one audio stream during processing of audio content based on a no volume condition associated with the at least one audio stream, in accordance with some examples of the present disclosure.

FIG. 2 is a block diagram of an illustrative aspect of software architecture implementable by a processor to disable audio decoding of at least one audio stream during processing of audio content based on a no volume condition associated with the at least one audio stream, in accordance with some examples of the present disclosure.

FIG. 3 is a block diagram of an illustrative aspect of software architecture implementable by a processor to disable audio encoding of at least one audio stream during processing of audio content based on a no volume condition associated with the at least one audio stream, in accordance with some examples of the present disclosure.

FIG. 4 is a diagram of an illustrative aspect of a system operable to disable audio coding during processing of media content that includes an audio stream based on a no volume condition associated with the audio stream, where the system includes an always-on power domain and a second power domain.

FIG. 5 illustrates an example of an integrated circuit operable to disable audio encoding of at least one audio stream during processing of audio content based on a no volume condition associated with the at least one audio stream, in accordance with some examples of the present disclosure.

FIG. 6 is a diagram of a mobile device operable to disable audio encoding of at least one audio stream during processing of audio content based on a no volume condition associated with the at least one audio stream, in accordance with some examples of the present disclosure.

FIG. 7 is a diagram of a headset operable to disable audio encoding of at least one audio stream during processing of audio content based on a no volume condition associated with the at least one audio stream, in accordance with some examples of the present disclosure.

FIG. 8 is a diagram of a wearable electronic device operable to disable audio encoding of at least one audio stream during processing of audio content based on a no volume condition associated with the at least one audio stream, in accordance with some examples of the present disclosure.

FIG. 9 is a diagram of a voice-controlled speaker system operable to disable audio encoding of at least one audio stream during processing of audio content based on a no volume condition associated with the at least one audio stream, in accordance with some examples of the present disclosure.

FIG. 10 is a diagram of a camera operable to disable audio encoding of at least one audio stream during processing of audio content based on a no volume condition associated with the at least one audio stream, in accordance with some examples of the present disclosure.

FIG. 11 is a diagram of a headset, such as a virtual reality, mixed reality, or augmented reality headset, operable to disable audio encoding of at least one audio stream during processing of audio content based on a no volume condition associated with the at least one audio stream, in accordance with some examples of the present disclosure.

FIG. 12 is a diagram of a first example of a vehicle operable to disable audio encoding of at least one audio stream during processing of audio content based on a no volume condition associated with the at least one audio stream, in accordance with some examples of the present disclosure.

FIG. 13 is a diagram of a second example of a vehicle operable to disable audio encoding of at least one audio stream during processing of audio content based on a no volume condition associated with the at least one audio stream, in accordance with some examples of the present disclosure.

FIG. 14 is a diagram of a particular implementation of a method operable to disable audio encoding of at least one audio stream during processing of audio content based on a no volume condition associated with the at least one audio stream that may be performed by the device of FIG. 1, in accordance with some examples of the present disclosure.

FIG. 15 is a block diagram of a particular illustrative example of a device that is operable to disable audio encoding of at least one audio stream during processing of audio content based on a no volume condition associated with the at least one audio stream, in accordance with some examples of the present disclosure.

### V. DETAILED DESCRIPTION

Computing devices often incorporate functionality to record and play audio content, video content, or both. Processing audio content is a source of power usage for such computing devices. According to the present disclosure, power usage associated with processing audio content is reduced by stopping the use of computing device resources to process audio content when the device is in a “no volume” condition.

According to an aspect, the device determines there is a no volume condition based on a microphone sensitivity setting, volume level setting (e.g., a volume setting is at zero as controlled by volume up/down buttons, a volume bar or other volume graphic, etc.), based on a volume on/off setting (e.g., a volume on/off setting is on mute), based on analysis of audio stream content (e.g., the audio stream content comprises silence frames), or combinations thereof. The microphone sensitivity setting, the volume level setting, or both, may be at default levels when the device is powered on and may be adjusted by a user of the device during use. During recording or playback of media content that includes at least one audio stream when there is a no volume condition, the device disables audio coding of the at least one audio stream. Audio coding includes audio encoding when the device is processing audio received by one or more microphones, recording media content, or both; and audio coding includes audio decoding when the device is in use to playback media content.

Systems and methods of disabling audio coding of at least one audio stream of media content by a device based on a no volume condition are disclosed. For example, a user of a tablet computer may record video of an unusual outside weather condition through an open door while ambient audio includes sound from people, a television, other audio sources, or combinations thereof. To avoid recording the ambient audio, the user may adjust one or more settings (e.g., reduce microphone sensitivity to zero via a graphical user interface) to have a no volume condition. In response to detection of the no volume condition, the tablet computer records video content without using one or more audio encoders to process audio input received by the tablet computer. As another example, during a commute, a user of a phone may watch media content in a no volume condition (e.g., the phone is in a mute mode). In response to the phone detecting the no volume condition, the phone processes the media content without using audio decoders to process one or more audio streams of the media content. As yet another example, during a call or teleconference session between a user using a device (e.g., a phone, computer, or other type of device) and one or more other parties, the user may mute the call (i.e., set a no volume condition) so that audio received by a microphone of the device is not sent to the one or more other parties. In response to the device detecting the no volume condition, the device does not process input received by the microphone until the device receives input that indicates a use volume condition. For battery powered devices, processing media content without audio coding extends a time of use of the device before the battery has to be recharged.

Thus, as compared to audio encoding and decoding by a conventional device in which a volume condition associated with the conventional device is not taken into consideration and audio coding is utilized even if the device is in a no volume condition, the disclosed systems and methods enable an extension of use time of a battery powered device and to limit power usage by battery powered devices and non-battery powered devices, by not performing audio encoding of input received via one or more microphones and audio coding during recording of media content or during playback of media content when a no volume condition is detected. According to some implementations, selective disabling of audio coding for media content when the device is in a no volume condition can be implemented at a processor level and can be independent of a particular application or program used to process the media content. In some implementations, selective disabling of audio coding for media content when the device is in a no volume condition is implemented at an application level by one or more applications configured to record media content, play content, or both. According to a particular aspect, power saving of from 5% to 20% can be obtained by a device processing media content without using audio coding when in a no volume condition as compared to a device processing the media content using audio coding when the device is in the no volume condition.

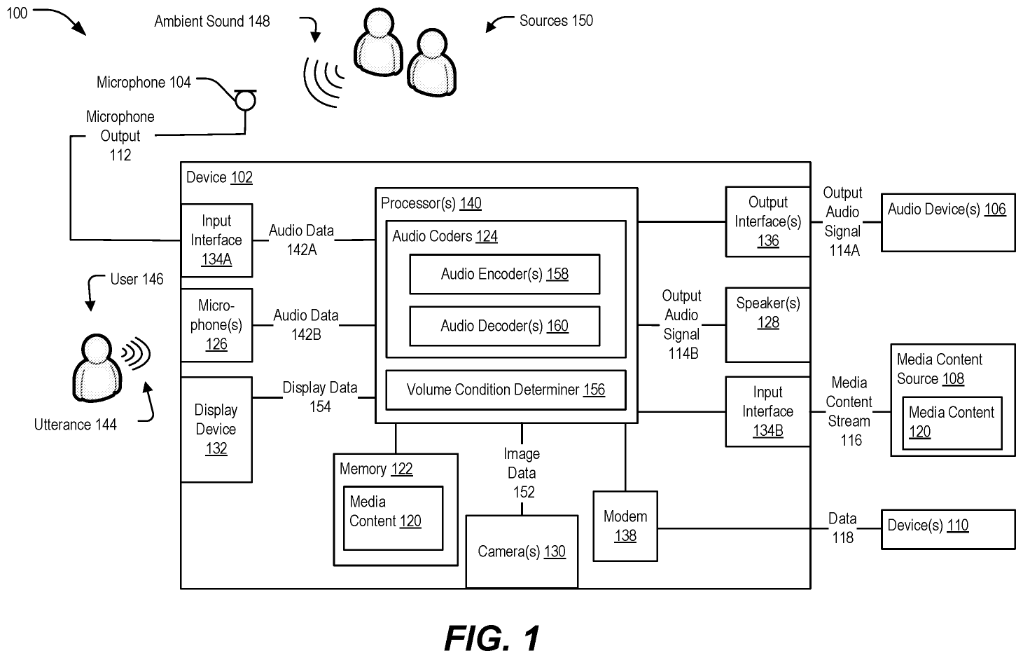

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 140 of FIG. 1), which indicates that in some implementations the device 102 includes a single processor 140 and in other implementations the device 102 includes multiple processors 140. For ease of reference herein, such features are generally introduced as “one or more” features or “at least one” feature and are subsequently referred to in the singular unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, output audio signals are illustrated and associated with reference numbers 114A and 114B. When referring to a particular one of these output audio signals, such as the output audio signal 114A, the distinguishing letter “A” is used. However, when referring to any arbitrary one of these output audio signals or to these output audio signals as a group, the reference number 114 is used without a distinguishing letter.

As used herein, the terms “comprise,” “comprises,” and “comprising” may be used interchangeably with “include.” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third.” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled.” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 discloses a particular illustrative aspect of a system 100 configured to disable audio coding during processing of media content that includes at least one audio stream based on a no volume condition being associated with the at least one audio stream. The system 100 depicted in FIG. 1 includes a device 102 coupled to a microphone 104, at least one audio device 106, a media content source 108, and at least one second device 110. In various implementations, the device 102 is configured to receive microphone output 112 from the microphone 104, provide an output audio signal 114A to the audio device 106, receive a requested media content stream 116 from the media content source 108, and transfer data 118 to and from the second device 110. The microphone 104 may be a directional microphone or an omnidirectional microphone.

The device 102 is configured to process media content 120, such as by recording and saving the media content 120 to a memory 122 of the device 102, processing audio content received by the device 102 via the microphone 104 and/or one or more other microphones 126 for transmittal to one or more other devices, playing back media content 120 received by the device 102 as the media content stream 116, playing back media content 120 saved in the memory 122 of the device 102, or combinations thereof. The media content 120 saved in the memory 122 of the device 102 may include media content 120 recorded by the device 102, media content 120 downloaded from the media content source 108, media content 120 received from the second device 110, media content 120 from other sources, or combinations thereof. Media content 120 may include image content, video content, audio content, or combinations thereof. For example, the media content 120 may include at least one video stream, at least one audio stream, or both.

When the media content 120 includes at least one audio stream, processing of the media content 120 by the device 102 is based on a volume condition associated with the at least one audio stream. As an example, when the device 102 is recording media content 120, the volume condition is based on a microphone sensitivity setting of the device 102. The microphone sensitivity setting may be set using a graphic user interface of an application used to record the media content 120, a graphic user interface of the device 102, one or more controls of the device (e.g., volume controls), by other means, or combinations thereof.

In another example, when the device 102 is playing back media content 120 or processing audio input received by the microphone 104 and/or the microphone 126 for transmittal to the second device 110, the volume condition is based on an analysis of audio content (e.g., an analysis to determine if the audio content includes a number of consecutive silence frames), an audio output setting for the device 102, or both. The output audio setting may be set by using volume controls of the device 102, by using a graphical user interface of the device 102 or an application providing playback of the media content 120, by enabling or disabling a mute mode of the device 102 via a user control or a graphic user interface, by other means, or combinations thereof.

The device 102 is configured to selectively use audio coders 124 during processing of the media content 120 based on the volume condition. For example, when the volume condition indicates a “use volume” condition, the device 102 processes the media content 120 using one or more audio coders 124. When the volume condition indicates a no volume condition, the device 102 processes the media content 120 without using the audio coders 124. During processing of the media content 120, the volume condition may change from a use volume condition to a no volume condition, and the device 102 stops use of the audio coders 124 based on the change. Similarly, during processing of the media content 120, the volume condition may change from a no volume condition to a use volume condition, and the device 102 starts use of one or more appropriate audio coders 124 based on the change.

The device 102 includes the memory 122, the microphone(s) 126, at least one speaker 128, at least one camera 130, a display device 132, input interfaces 134, output interfaces 136, a modem 138, and one or more processors 140. The memory 122 is configured to receive recorded media content 120 from the processor 140 and to provide saved media content 120 to the processor 140.

As noted above, the device 102 is configured to receive input data corresponding to media content 120 via various input sources. To illustrate, the microphone 126 is configured to provide audio data 142B corresponding to audio input received by the microphone 126 to the processor 140. In an example, the audio input includes utterances 144 and other sounds produced by a user 146 and ambient sound 148 from other audio sources 150 (e.g., people, animals, machinery, nature, etc.). The input interface 134A is configured to receive microphone output 112 corresponding to the ambient sound 148 from the microphone 104 and provide audio data 142A based on the microphone output 112 to the processor 140. The input interface 134B is configured to receive the media content stream 116 and provide the media content stream 116 to the processor 140. The camera 130 is configured to provide image data 152, such as video data, to the processor 140 when the camera 130 is active. The modem 138 is configured to transmit data to and receive data from the second device 110, such as data including media content 120.

The device 102 is also configured to generate outputs for the user 146. To illustrate, the speaker 128 is configured to receive an output audio signal 114B from the processor 140 and provide audio output to the user 146 when the speaker 128 is active. The display device 132 is configured to receive display data 154 and provide visual output to the user 146.

The processor 140 includes the audio coders 124 and a volume condition determiner 156. The audio coders 124 include at least one audio encoder 158 configured to encode the at least one audio stream when the device 102 is in use to record the media content 120, process audio input received by the microphones 104, 126, or both. The audio coders 124 also include at least one audio decoder 160 configured to decode the at least one audio stream when the device 102 is in use to playback the media content 120. The volume condition determiner 156 is configured to monitor settings of the device 102, such as settings that are set via one or more interfaces or controls of the device 102, and monitor input to the device 102, such as analyzing audio streams for periods of silence, to determine a volume condition of the device 102.

During processing of media content 120, the processor 140 determines whether to use one or more of the audio coders 124 based on output of the volume condition determiner 156. To illustrate, the volume condition determiner 156 monitors settings of the device 102 and input to the device 102 to determine the volume condition. When the volume condition determiner 156 indicates that the volume condition of the device 102 is a use volume condition, the processor 140 uses one or more of the audio coders 124 to process the at least one audio stream. When the volume condition determiner 156 indicates that the volume condition of the device 102 is a no volume condition, the processor 140 does not use the audio coders 124 to process the at least one audio stream and does not generate an output audio signal 114.

In some implementations, the device 102 may receive first input that instructs the processor 140 to record media content 120 via a media application, and the input sources for the media content 120 do not include image data from the camera 130. In response to the first input, the processor 140 creates a file for the media content 120. When the volume condition determiner 156 indicates the use volume condition, the media application causes output from the audio decoder 160 to be included in the file until a stop recording input is received or the volume condition determiner 156 indicates a change to the no volume condition. For example, in a first particular implementation, when the volume condition determiner 156 indicates the no volume condition, the audio decoder 160 does not generate output, and the media application stops recording and completes the file. In a second particular implementation, when the volume condition determiner 156 indicates the no volume condition, the media application fills the file with silence frames until output from the audio decoder 160 is received, until a stop recording input is received by the device 102, or until a threshold time is exceeded. In a third particular implementation when the volume condition determiner 156 indicates the no volume condition, the media application pauses generation of the file until output from the audio decoder 160 is received, until a stop recording input is received by the device 102, or until the threshold time is exceeded. When the threshold time is exceeded or the stop recording input is received, the media application stops recording and completes the file.

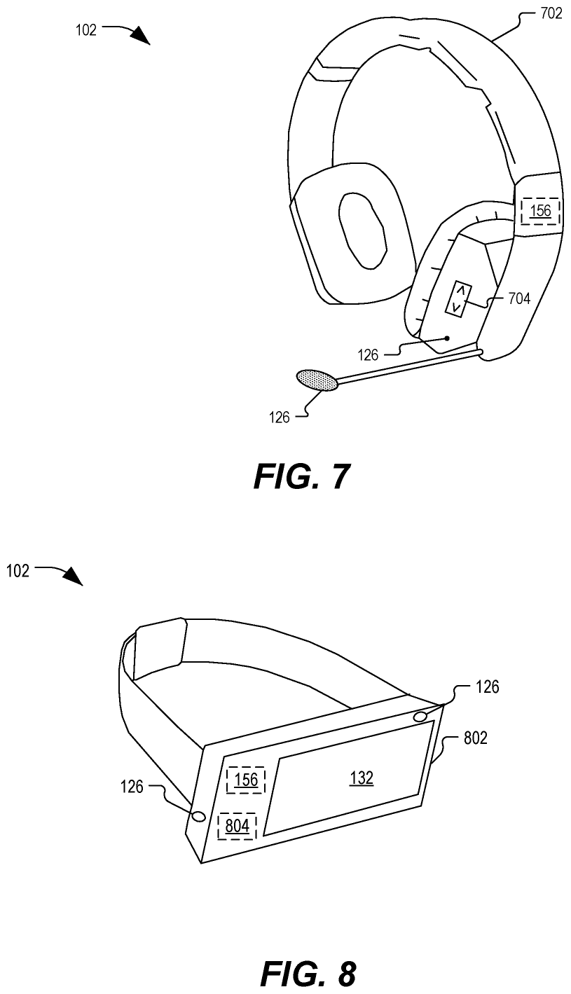

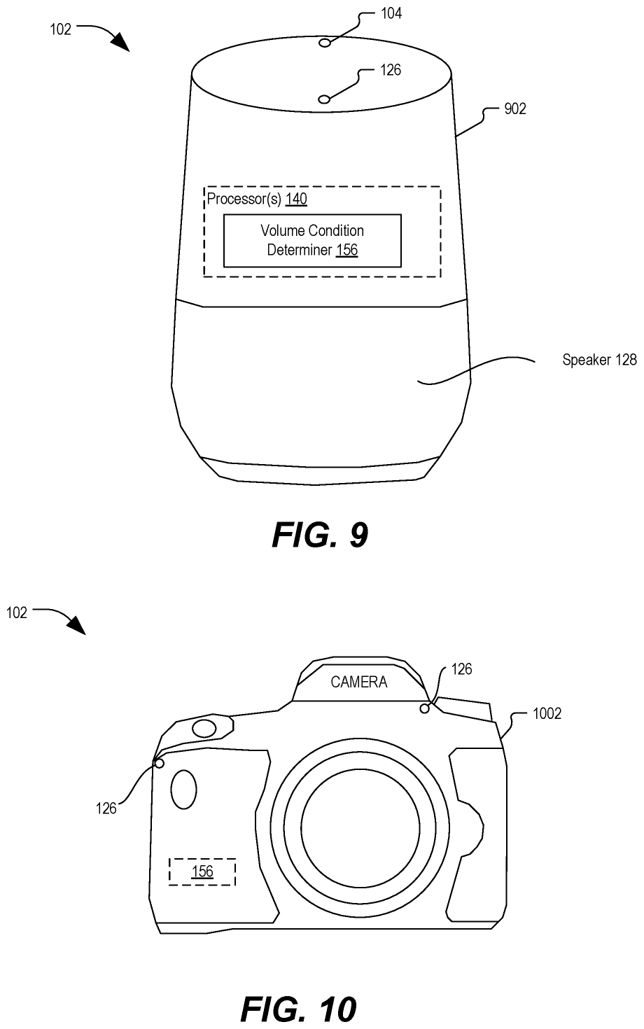

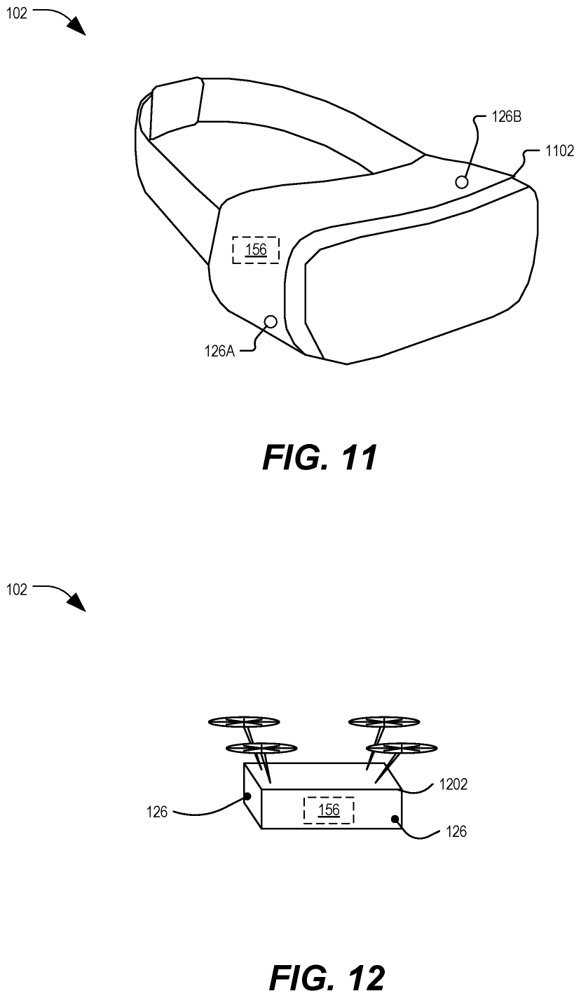

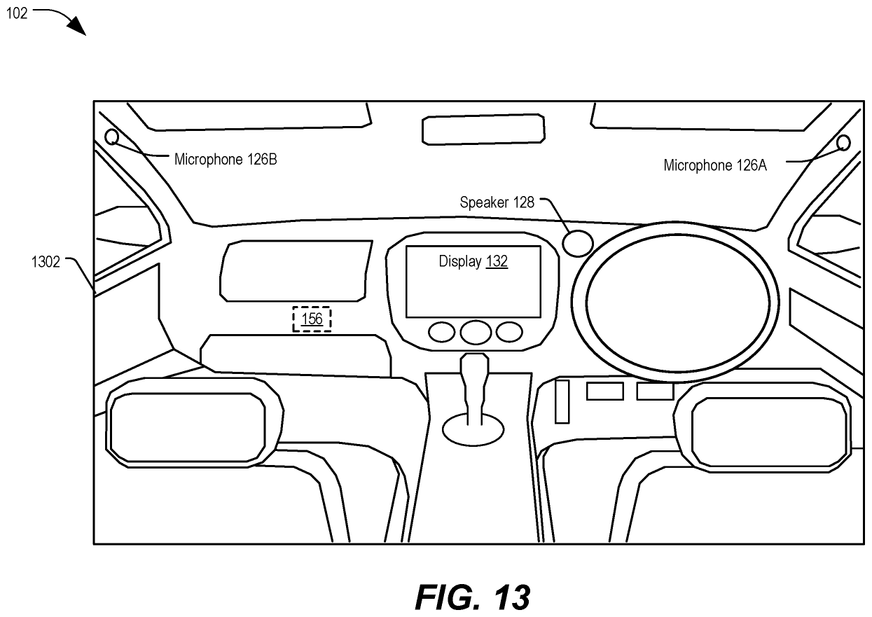

In some implementations, the device 102 corresponds to or is included in one of various types of devices. In an illustrative example, the processor 140 is integrated in a headset device that includes the microphones 104, 126, such as described further with reference to FIG. 7. In other examples, the processor 140 is integrated in at least one of a mobile phone or a tablet computer device, as described with reference to FIG. 6, a wearable electronic device, as described with reference to FIG. 8, a voice-controlled speaker system, as described with reference to FIG. 9, a camera device, as described with reference to FIG. 10, or a virtual reality, mixed reality, or augmented reality headset, as described with reference to FIG. 11. In another illustrative example, the processor 140 is integrated into a vehicle that also includes the microphone 126, such as described further with reference to FIG. 12 and FIG. 13.

During operation, the device 102 receives input, via an application or program accessible to the processor 140, to process media content 120 that includes at least one audio stream. In response to the input, the device 102 obtains the media content 120. When the device 102 is recording the media content 120, input content is obtained by the device from camera 130, microphones 104, 126, other input devices, or combinations thereof, and the device 102 generates the media content 120 from the input content and saves the media content 120 to the memory 122, streams the media content to another device 110 via the modem 138, or both. When the device 102 is playing back media content 120, the device 102 obtains the media content 120 from a media content source 108 or from the memory 122 and provides output corresponding to the media content 120 to the display device 132, audio device 106, speaker 128, or combinations thereof, based on one or more settings of the device 102.

The volume condition determiner 156 of the device 102 determines a volume condition associated with the device 102 during the processing of the media content 120. When the volume condition determiner 156 determines that the volume condition is in a use volume condition (e.g., microphone sensitivity is not set to zero, audio output to be provided to the audio devices 106 and/or the speaker 128 is not zero, or both), the device 102 uses one or more of the audio coders 124 to process the at least one audio stream of the media content 120. When the volume condition determiner 156 determines that the volume condition of the device 102 is in a no volume condition (e.g., microphone sensitivity is set to zero, audio output to be provided to the audio device 106 and/or the speaker 128 is zero, or both), the device 102 does not use one or more of the audio coders 124 to process the at least one audio stream. Thus, when the device 102 is in a no volume condition, the device 102 decreases power usage by not processing the at least one audio stream of the media content 120. Having the ability to not process the at least one audio stream when the device 102 is in a no volume condition reduces power usage by the device 102, heat generation by the device 102, and, when the device 102 is a battery powered device, extends a use time of the device 102 before the device 102 needs to be recharged as compared to another device that continues to process the at least one audio stream when in the no volume condition.

Although the microphone 104 is illustrated as being coupled to the device 102, in other implementations the microphone 104 may be included in or integrated with the device 102, such as the microphone 126 that is integrated in the device 102. Although the two microphones 104, 126 are illustrated, in other implementations one or more additional microphones configured to capture user speech, one or more microphones configured to capture environmental sounds, or both, may be included. Although the system 100 is illustrated as including the second device 110, in other implementations the second device 110 may be omitted. Although the display device 132 and the at least one camera 130 are shown as integrated in the device 102, one or more external displays and one or more external cameras may be coupled to the device 102. In other implementations, the system 100 may include additional components or fewer components. For example, the system 100 may not include the microphone 104, the audio device 106, or both; the system 100 may not be configured to receive the media content stream 116 from the media content source 108; the system 100 may include at least one external camera, display device, or both; or combinations thereof.

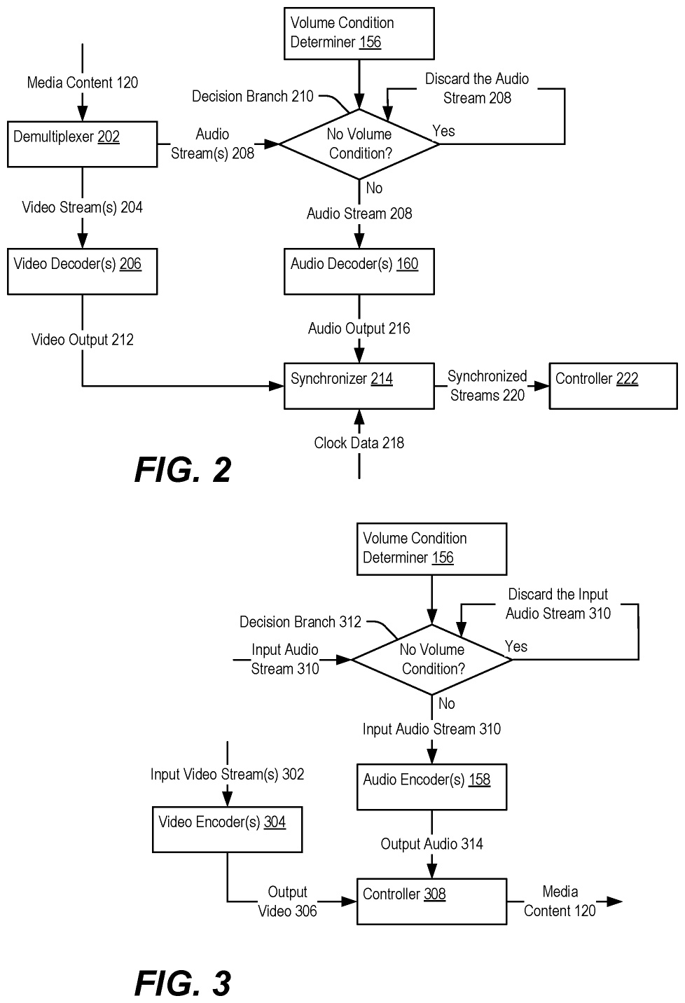

FIG. 2 is a block diagram of an illustrative aspect of software architecture implementable by the processor 140 when the device 102 receives input to playback media content 120 using a media application. Media content 120 is obtained and provided to a de-multiplexer 202. When the media content 120 includes video content and audio content, the de-multiplexer 202 provides one or more video streams 204 to video decoders 206 and one or more audio streams 208 to a decision branch 210. When the media content 120 includes only video content, the de-multiplexer 202 provides the video stream 204 to the video decoder 206. When the media content 120 includes only audio content, the de-multiplexer 202 provides the audio stream 208 to the decision branch 210. The video decoder 206 processes the video stream 204 and provides video output 212 to a synchronizer 214.

The decision branch 210 receives input indicating a volume condition of the device 102 from the volume condition determiner 156. The input may indicate that the volume condition of the device 102 is a no volume condition or a use volume condition.

When the input received by the decision branch 210 indicates a use volume condition (e.g., a “No” decision at the decision branch 210), the audio stream 208 is provided to the audio decoder 160, and audio output 216 generated by the audio decoder 160 is provided to the synchronizer 214. Otherwise, when the input received by the decision branch 210 indicates a no volume condition (e.g., a “Yes” decision), operation of the audio decoder 160 is disabled by not providing (e.g., transmitting) the audio stream 208 to the audio decoder 160 while the volume condition of the device 102 remains at the no volume condition, and one or more portion of the audio stream 208 corresponding to the time period associated with the no volume condition are discarded.

When the volume condition determiner 156 determines that a duration of time that the device 102 is in the no volume condition has exceeded a threshold duration (e.g. 0.5 seconds, 1 second, 5 seconds, or some other amount of time), the volume condition determiner 156 may send a signal that causes the audio decoder 160 to turn off (e.g., be depowered) until the volume condition determiner 156 sends another signal that causes the audio decoder to turn on (i.e., be powered) based on a change from the no volume condition to the use volume condition detected by the volume condition determiner 156 when a detection indicates that the audio decoder 160 is turned off.

The synchronizer 214 receives clock data 218, such as provided by a program reference clock or a system clock. When the synchronizer 214 receives the video output 212 and the audio output 216, the synchronizer 214 provides synchronized streams 220 of audio and video based on the clock data 218 to a controller 222. Audio/video synchronization is not affected by transitions from the no volume condition to the use volume condition since the synchronization is based on the clock data 218 that allows association of audio frames with corresponding video frames, and is not based on audio timestamp references. The controller 222 provides the synchronized streams 220 to appropriate output devices (e.g., the display device 132, the audio device 106, the speaker 128, other output devices, or combinations thereof). Otherwise, when the synchronizer 214 only receives one of the video output 212 or the audio output 216, the synchronizer 214 provides the received stream to the controller 222.

FIG. 3 is a block diagram of an illustrative aspect of software architecture implementable by the processor 140 when the device 102 receives input to record media content 120 using a media application. At least one input video stream 302 is provided to at least one video encoder 304. For example, the input video stream 302 may be provided by the camera 130. Output video 306 from the video encoder 304 is provided to a controller 308.

At least one input audio stream 310 is provided to a decision branch 312. The input audio stream 310 includes audio data 142 received via the microphones 104, 126. The decision branch 312 also receives input indicating a volume condition of the device 102 from the volume condition determiner 156. The input may indicate that the volume condition of the device 102 is a no volume condition or a use volume condition.

When the input received by the decision branch 312 indicates a use volume condition (e.g., a “No” decision at the decision branch 312), the input audio stream 310 is provided to the audio encoder 158, and output audio 314 from the audio encoder 158 is provided to the controller 308. Otherwise, when the input received by the decision branch 312 indicates a no volume condition (e.g., a “Yes” decision), operation of the audio encoder 158 is disabled by not providing (e.g., transmitting) the input audio stream 310 to the audio encoder 158 while the volume condition of the device 102 remains at the no volume condition, and one or more portion of the input audio stream 310 (corresponding to the time period associated with the no volume condition) are discarded.

When the volume condition determiner 156 determines that a duration of time that the device 102 is in the no volume condition has exceeded a threshold duration (e.g. 0.5 seconds, 1 second, 5 seconds, or some other amount of time) the volume condition determiner 156 may send a signal that causes the at least one audio encoder 158 to turn off (e.g., be depowered) until the volume condition determiner 156 sends another signal that causes the audio decoder to turn on (i.e., be powered) based on a change from the no volume condition to the use volume condition detected by the volume condition determiner 156 when a detection indicates that the audio encoder 158 is turned off.

The controller 308 outputs the media content 120 based on received output video 306 and received output audio. In an example, the media content 120 is saved to a file, streamed to one or more devices, or both.

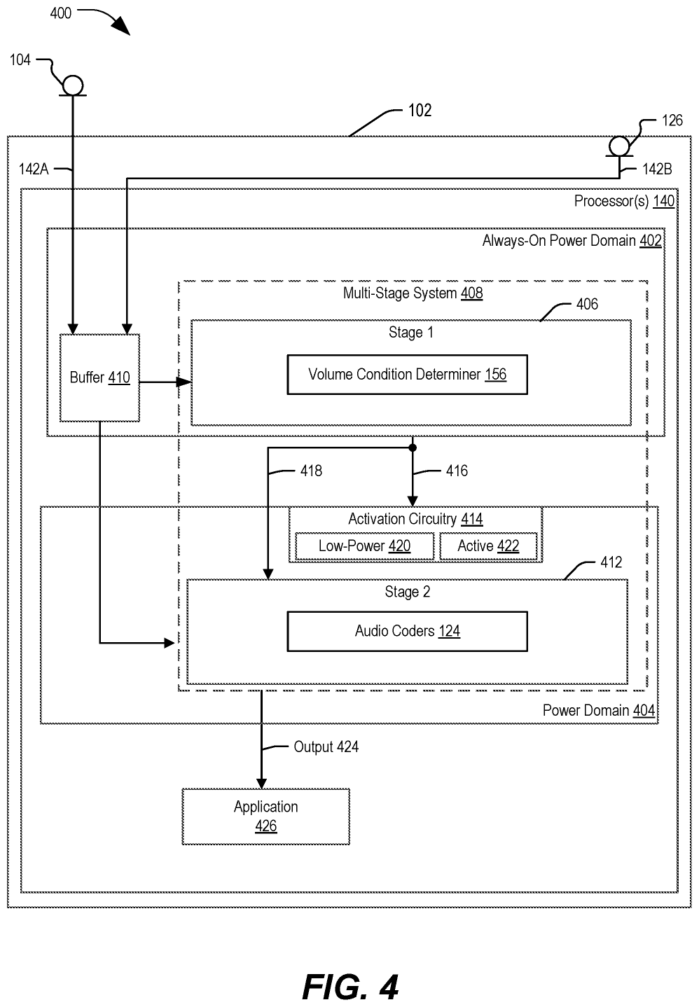

FIG. 4 is a block diagram of an illustrative aspect of a system 400 operable to disable audio coding during processing of media content that includes at least one audio stream based on a no volume condition being associated with the at least one audio stream, in accordance with some examples of the present disclosure, in which the processor 140 includes an always-on power domain 402 and a second power domain 404, such as an on-demand power domain. In some implementations, a first stage 406 of a multi-stage system 408 for audio coding and a buffer 410 are configured to operate in an always-on mode, and a second stage 412 of the multi-stage system 408 is configured to operate in an on-demand mode.

The always-on power domain 402 includes the buffer 410 and the first stage 406. The buffer 410 is configured to store the audio data 142A, 142B from the microphones 104, 126 to be accessible for processing by components of the multi-stage system 408. The second power domain 404 includes the second stage 412 of the multi-stage system 408 and also includes activation circuitry 414.

The first stage 406 of the multi-stage system 408 includes the volume condition determiner 156 and is configured to generate at least one of a sleep/wakeup signal 416 or an interrupt 418 to initiate one or more operations at the second stage 412. In an example, the sleep/wakeup signal 416 is configured to transition the second power domain 404 from an active mode 422 to a low-power mode 420 to deactivate one or more components of the second stage 412 including one or more of the audio coders 124, so that the audio coders 124 are deactivated (e.g., turned off) when the volume condition determiner 156 detects that the no volume condition has persisted longer than a threshold time period. In an example, the sleep/wakeup signal 416 is configured to transition the second power domain 404 from the low-power mode 420 to the active mode 422 to activate one or more components of the second stage 412 including one or more of the audio coders 124 to resume processing of the audio data 142A, 142B when the use volume condition is restored, so that the audio coders 124 are activated (turned on) when the volume condition determiner detects a transition from the no volume condition to the use volume condition.

For example, the activation circuitry 414 may include or be coupled to power management circuitry, clock circuitry, head switch or foot switch circuitry, buffer control circuitry, or any combination thereof. The activation circuitry 414 may be configured to initiate powering-on of the second stage 412, such as by selectively applying or raising a voltage of a power supply of the second stage 412, of the second power domain 404, or both. As another example, the activation circuitry 414 may be configured to selectively gate or un-gate a clock signal to the second stage 412, such as to prevent or enable circuit operation without removing a power supply.

An output 424 generated by the second stage 412 of the multi-stage system 408 is provided to an application 426. The application 426 can correspond to a media content recorder application, to a media content playback application, or to a communication application that enables audio communication with one or more additional parties, as illustrative, non-limiting examples. By selectively deactivating the second stage 412 based on a determination at the first stage 406 of the multi-stage system 408 that audio coding should be disabled and the audio coders 124 deactivated during extended periods when there is a no volume condition, overall power consumption associated with the device 102 may be reduced.

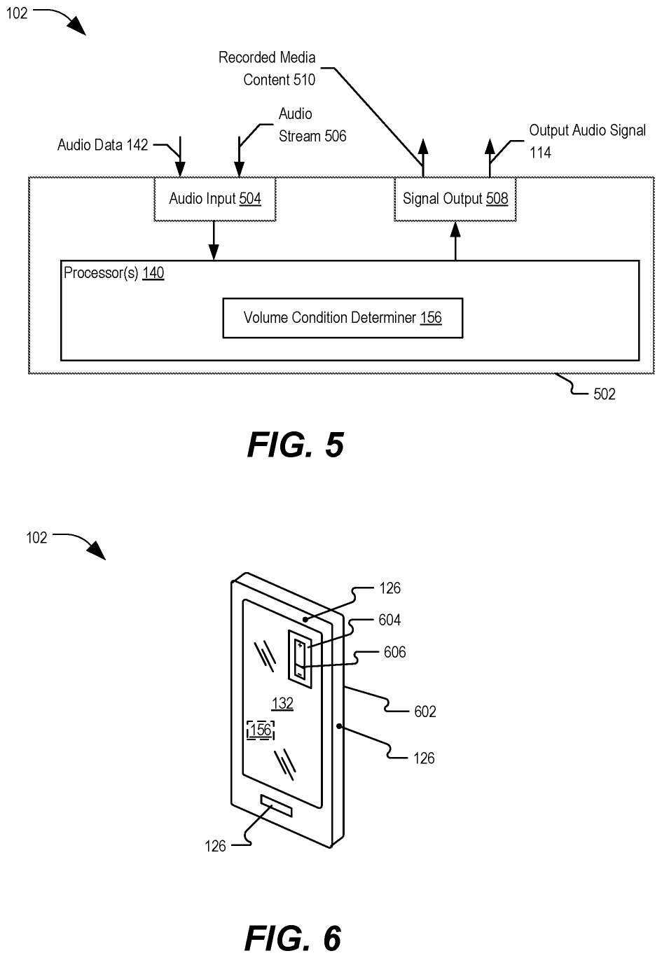

FIG. 5 depicts an implementation of the device 102 as an integrated circuit 502 that includes the at least one processor 140 with a volume condition determiner 156. The integrated circuit 502 also includes an audio input 504, such as one or more bus interfaces, to enable the audio data 142 or at least one audio stream 506 of media content 120 to be received for processing. The integrated circuit 502 also includes a signal output 508, such as a bus interface, to enable sending of recorded media content 510 to the memory 122 and an output audio signal 114 to the audio device 106, the speaker 128, or both. The integrated circuit 502 enables implementation of disabling audio coding during processing of media content 120 that includes at least one audio stream based on a no volume condition being associated with the at least one audio stream. The volume condition determiner 156 is configured to determine if a volume condition is a no volume condition or a use volume condition. The integrated circuit 502 may be a component in a system that includes microphones (e.g., microphones 104, 126) and audio devices (e.g., the audio device 106, the speaker 128, or both), such as a mobile phone or tablet computer as depicted in FIG. 6, a headset as depicted in FIG. 7, a wearable electronic device as depicted in FIG. 8, a voice-controlled speaker system as depicted in FIG. 9, a camera as depicted in FIG. 10, a virtual reality, mixed reality, or augmented reality headset as depicted in FIG. 11, or a vehicle as depicted in FIG. 12 or FIG. 13.

FIG. 6 depicts an implementation in which the device 102 includes a mobile device 602, such as a phone or tablet, as illustrative, non-limiting examples. The mobile device 602 includes the microphones 126 and a display device 132. The display device 132 is configured to display a graphic user interface 604. As an illustrative example, the graphic user interface 604 may display a volume control that enables a user to adjust an output volume associated with speakers of the mobile device 602 by moving a volume level indicator 606 up or down. Components of the processor 140, including the volume condition determiner 156, are integrated in the mobile device 602 and are illustrated using dashed lines to indicate internal components that are not generally visible to a user of the mobile device 602. In a particular example, when the volume condition determiner 156 indicates that the mobile device 602 is in a no volume condition during processing of media content, audio coding of at least one audio stream of the media content is disabled, which reduces power consumption and extends a use time of the mobile device 602 on a single charge.

FIG. 7 depicts an implementation in which the device 102 includes a headset device 702. The headset device 702 includes the microphones 126, a volume up and volume down control 704, and components of the processor 140, including the volume condition determiner 156, are integrated in the headset device 702. In a particular example, the headset device 702 may be used by a user participating in a conference call. The headset device 702 may be configured to go into a no volume mode when the user taps a portion of the headset device 702 in a particular way. In response to the volume condition determiner 156 determining that the headset device 702 is in the no volume condition, the processor 140 does not process audio content received from the microphone 104 for transmittal to another device that is in communication with the headset device 702 and that is configured to facilitate the conference call.

FIG. 8 depicts an implementation in which the device 102 includes a wearable electronic device 802, illustrated as a “smart watch.” The volume condition determiner 156, the microphones 126, and a rechargeable battery 804 are integrated into the wearable electronic device 802. In a particular example, the volume condition determiner 156 operates to detect a volume condition associated with the wearable electronic device 802. When the volume condition determiner 156 determines that the wearable electronic device 802 is in a no volume condition, the wearable electronic device 802 does not use audio coders to process media content played by the wearable electronic device 802, audio input received via the microphones 126, or both. In some implementations, when the media content played by the wearable electronic device 802 only includes audio content, the wearable electronic device 802 stops playback of the media content after passage of a threshold amount of time while in the no volume condition. In some implementations, when the media content played by the wearable electronic device 802 only includes audio content, the wearable electronic device 802, provides a signal (e.g., a visual signal, haptic signal, or both) to indicate that the wearable electronic device 802 is processing the media content and provides an option to stop processing the media content.

FIG. 9 is an implementation in which the device 102 includes a wireless speaker and voice activated device 902. The wireless speaker and voice activated device 902 can have wireless network connectivity and is configured to execute an assistant operation. The processor 140 including the volume condition determiner 156, the microphones 126, or a combination thereof, are included in the wireless speaker and voice activated device 902. The wireless speaker and voice activated device 902 also includes a speaker 128. In a particular example of use of the wireless speaker and voice activated device 902, the wireless speaker and voice activated device 902 is used to establish a voice over internet protocol (VOIP) call. A user may give a command to mute the call while the call is ongoing. When the user mutes the call, the volume condition determiner 156 detects that the wireless speaker and voice activated device 902 is in a no volume condition. The processor 140 disables the use of audio coders for input received from the microphones 126 until the wireless speaker and voice activated device 902 receives a command to unmute the call.

FIG. 10 depicts an implementation in which the device 102 includes a portable electronic device that corresponds to a camera device 1002. The volume condition determiner 156, the microphones 126, or both, are included in the camera device 1002. During use, a user of the camera device 1002 may enter input that stops media content produced by the camera from including an audio stream generated from audio received via the microphones 126. In response to receiving the input, the volume condition determiner 156 indicates that the camera device 1002 is in a no volume condition and use of audio encoders is disabled.

FIG. 11 depicts an implementation in which the device 102 includes a portable electronic device that corresponds to a virtual reality, mixed reality, or augmented reality headset 1102. The volume condition determiner 156, the microphones 126, or both, are integrated into the headset 1102. In a particular aspect, the headset 1102 includes the first microphone 126A positioned to primarily capture speech of a user and the second microphone 126B positioned to primarily capture environmental sounds. User voice activity detection can be performed based on audio signals received from the first microphone 126A and the second microphone 126B of the headset 1102. A visual interface device is positioned in front of the user's eyes to enable display of augmented reality, mixed reality, or virtual reality images or scenes to the user while the headset 1102 is worn. In a particular example, the user of the headset 1102 can activate a control of the headset 1102 to mute audio content. When the user activates the control to mute the audio, the volume condition determiner 156 detects that the headset 1102 is in the no volume condition and use of decoders for audio of media content played by the headset 1102 is disabled.

FIG. 12 depicts an implementation in which the device 102 corresponds to, or is integrated within, a vehicle 1202, illustrated as a manned or unmanned aerial device (e.g., an advertising drone). The volume condition determiner 156, the microphones 126, or both, are integrated into the vehicle 1202. In an implementation, the vehicle 1202 includes a display screen and speakers to output media content. When the vehicle 1202 is proximate to certain areas (e.g., hospitals, schools, etc.), the vehicle 1202 may enter a mute mode and stop use of the speakers. The volume condition determiner 156 detects that the vehicle 1202 is the no volume condition when the vehicle 1202 enters the mute mode and the use of decoders to process one or more audio streams of the media content is disabled until the vehicle 1202 receives enters an unmute mode.

FIG. 13 depicts another implementation in which the device 102 corresponds to, or is integrated within, a vehicle 1302, illustrated as a car. The vehicle 1302 includes the processor 140 including the volume condition determiner 156. The vehicle 1302 also includes the microphones 126. The first microphone 126A is positioned to capture utterances of an operator of the vehicle 1302. User voice activity detection can be performed based on audio signals received from the microphones 126. In some implementations, user voice activity detection can be performed based on an audio signal received from the microphones 126, such as for a voice command from an authorized passenger. For example, the user voice activity detection can be used to detect a voice command from an operator of the vehicle 1302 (e.g., from a parent to set a volume to 5 or to set a destination for a self-driving vehicle) and to disregard the voice of another passenger (e.g., a voice command from a child to set the volume to 10 or other passengers discussing another location). To illustrate, one or more microphones 126 proximate to the child's location in the vehicle 1302 may be deactivated, causing the volume condition associated with the audio input from those microphones 126 to be a no volume condition as detected by the volume condition determiner 156, and use of encoders to process one or more audio streams associated with those microphones 126 is disabled.

In some implementations, user voice activity detection can be performed based on an audio signal received from the microphones 126, such as an authorized user of the vehicle. In a particular implementation, in response to receiving a verbal command identified as user speech, a voice activation system initiates one or more operations of the vehicle 1302 based on one or more keywords (e.g., “unlock,” “start engine,” “play music,” “display weather forecast,” or another voice command) detected in the user speech, such as by providing feedback or information via a display device 132 or one or more speakers 128.

In some implementations, the vehicle 1302 may include one or more display devices that are located so that the one or more display devices are not visible to an operator of the vehicle 1302 (e.g., the one or more display devices are positioned behind the operator of the vehicle 1302). The one or more display devices are configured to display media content to entertain one or more passengers in the vehicle 1302. Control of media content played in the vehicle 1302 may be controlled via voice commands, input via the display device 132, or both. The volume condition determiner 156 determines a volume condition associated with media content played in the vehicle 1302. When the volume condition is a no volume condition as detected by the volume condition determiner 156, use of decoders to process one or more audio streams of the media content is disabled.

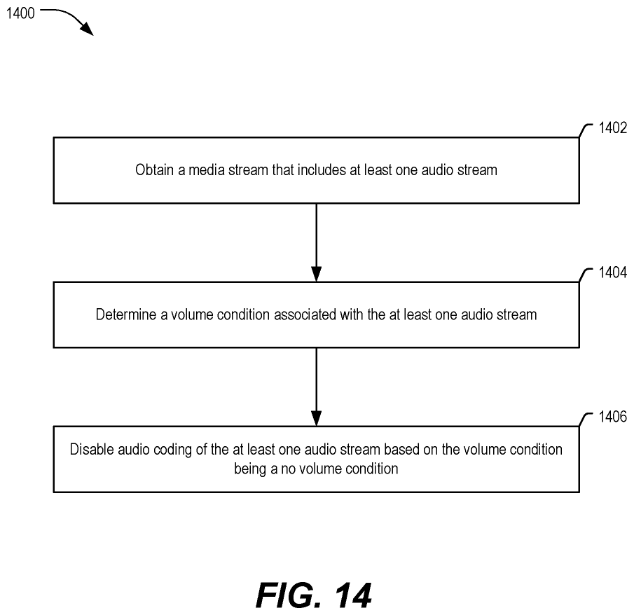

Referring to FIG. 14, a particular implementation of a method 1400 operable to disable audio encoding of at least one audio stream during processing of audio content based on a no volume condition associated with the at least one audio stream is shown. In a particular aspect, one or more operations of the method 1400 are performed by at least one of the processor 140, the device 102, the system 100 of FIG. 1, or a combination thereof.

The method 1400 includes obtaining a media stream that includes at least one audio stream, at 1402. For example, when the method 1400 is used to record media content, the media stream includes camera input, microphone input, or both. As another example, when the method 1400 is used to playback media content, the media stream may be obtained from a media content source 108, from media content 120 stored in a memory 122, or from another source.

The method 1400 includes determining a volume condition associated with the at least one audio stream, at 1404. For example, a volume condition determiner 156 of the device 102 may determine a volume condition of the device 102, which corresponds to the volume condition associated with the at least one audio stream.

The method 1400 includes disabling audio coding of the at least one audio stream based on the volume condition being a no volume condition, at 1406. For example, when the method 1400 is used to record media content, a decision branch 312 of software architecture is configured to disable audio coding of the at least one audio stream by not transmitting the at least one audio stream to at least one audio encoder 158 when input from the volume condition determiner 156 indicates the no volume condition. When the input indicates a use volume condition, the at least one audio stream is transmitted to the at least one encoder 158 to process the at least one audio stream. As another example, when the method 1400 is used to playback media content, a decision branch 210 of software architecture is configured to disable audio coding of the at least one audio stream by not transmitting the at least one audio stream to at least one audio decoder 160 when input from the volume condition determiner 156 indicates the no volume condition. When the input indicates a use volume condition, the at least one audio stream is transmitted to the at least one decoder 160 to process the at least one audio stream.

The method 1400 limits power usage when the no volume condition is detected as compared to a device that does not disable coding of the audio stream when there is a no volume condition. Limiting power usage can conserve resources, limit heat generation, and can extend a use time of the device on a single charge when the device is a battery powered device.

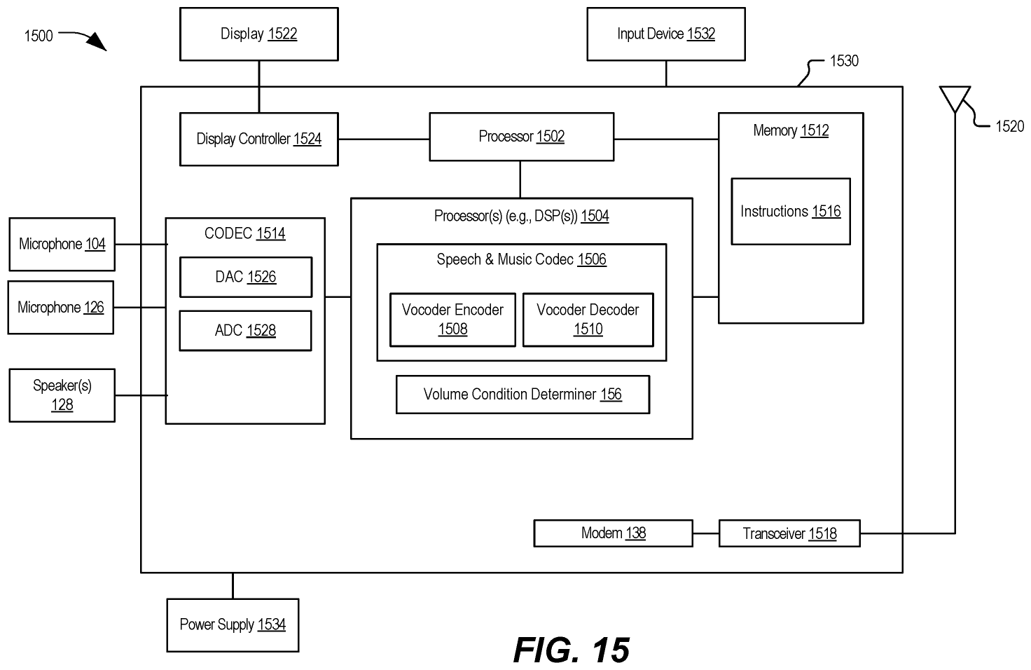

The method 1400 of FIG. 14 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1400 of FIG. 14 may be performed by a processor that executes instructions, such as described with reference to FIG. 15.

Referring to FIG. 15, a block diagram of a particular illustrative implementation of a device is depicted and generally designated 1500. In various implementations, the device 1500 may have more or fewer components than illustrated in FIG. 15. In an illustrative implementation, the device 1500 may correspond to the device 102. In an illustrative implementation, the device 1500 may perform one or more operations described with reference to FIGS. 1-14.

In a particular implementation, the device 1500 includes a processor 1502 (e.g., a central processing unit (CPU)). The device 1500 may include one or more additional processors 1504 (e.g., one or more DSPs). In a particular aspect, the processor 140 of FIG. 1 corresponds to the processor 1502, the processors 1504, or a combination thereof. The processors 1504 may include coders (e.g., a speech and music coder-decoder (CODEC) 1506) and a volume condition determiner 156. The volume condition determiner 156 may provide output used to determine whether the coders are enabled or disabled. The speech and music CODEC 1506 includes a voice coder (“vocoder”) encoder 1508, a vocoder decoder 1510, or both.

The device 1500 may include a memory 1512 and a CODEC 1514. The memory 1512 may include instructions 1516 that are executable by the one or more additional processors 1504 (or the processor 1502) to implement the functionality associated with the device 1500, including the functionality associated with the volume condition determiner 156 as described herein. The device 1500 may include the modem 138 coupled, via a transceiver 1518, to an antenna 1520.

The device 1500 may include a display 1522 (e.g., display device 132) coupled to a display controller 1524. The at least one speaker 128 and the microphones 104, 126 may be coupled to the CODEC 1514. The CODEC 1514 may include a digital-to-analog converter (DAC) 1526, an analog-to-digital converter (ADC) 1528, or both. In a particular implementation, the CODEC 1514 may receive analog signals from the microphones 104, 126, convert the analog signals to digital signals using the analog-to-digital converter 1528, and provide the digital signals to the speech and music CODEC 1506. The speech and music CODEC 1506 may process the digital signals when the volume condition determiner 156 indicates a use volume condition and may disable use of the speech and music CODEC 1506 when the volume condition determiner 156 indicates a no volume condition. In a particular implementation for playback of media content, the speech and music CODEC 1506 may provide digital signals to the CODEC 1514. The CODEC 1514 may convert the digital signals to analog signals using the digital-to-analog converter 1526 and may provide the analog signals to the speaker 128.

In a particular implementation, the device 1500 may be included in a system-in-package or system-on-chip device 1530. In a particular implementation, the memory 1512, the processor 1502, the processors 1504, the display controller 1524, the CODEC 1514, and the modem 138 are included in the system-in-package or system-on-chip device 1530. In a particular implementation, an input device 1532 and a power supply 1534 are coupled to the system-in-package or the system-on-chip device 1530. Moreover, in a particular implementation, as illustrated in FIG. 15, the display 1522, the input device 1532, the speaker 128, the microphones 104, 126, the antenna 1520, and the power supply 1534 are external to the system-in-package or the system-on-chip device 1530. In a particular implementation, each of the display 1522, the input device 1532, the speaker 128, the microphones 104, 126, the antenna 1520, and the power supply 1534 may be coupled to a component of the system-in-package or the system-on-chip device 1530, such as an interface (e.g., the input interfaces 134 or output interfaces 136) or a controller.

The device 1500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining a media stream that includes at least one audio stream. For example, the means for obtaining the media stream that includes the at least one audio stream can include processor 140, input interfaces 134, the modem 138, camera 130, the microphones 104, 126, one or more circuits or devices configured to obtain the media stream, or combinations thereof. The apparatus also includes means for disabling audio coding of the at least one audio stream based on a no volume condition associated with the at least one audio stream. For example, the means for disabling audio coding of the at least one audio stream based on the no volume condition associated with the at least one audio stream can include the processor 140, the volume condition determiner 156, the decision branches 210, 312, the activation circuitry 414, one or more circuits or devices configured to disable the audio coding based on the no volume condition, or combinations thereof.

In some implementations, a non-transitory computer-readable medium (e.g., a computer-readable storage device, such as the memory 122, 1512) includes instructions (e.g., the instructions 1516) that, when executed by one or more processors (e.g., the one or more processors 140, 1502, 1504), cause the one or more processors to obtain a media stream that includes at least one audio stream; and disable audio coding of the at least one audio stream based on a no volume condition associated with the at least one audio stream. The non-transitory computer-readable medium does not correspond to a signal.

Particular aspects of the disclosure are described below in sets of interrelated Examples:

According to Example 1, a device comprises: one or more processors configured to: obtain a media stream that includes at least one audio stream; and disable audio coding of the at least one audio stream based on a no volume condition associated with the at least one audio stream.

Example 2 includes the device of Example 1, further comprising a video decoder, at least one audio decoder, and a stream synchronizer, wherein the media stream further includes a video stream, and wherein the one or more processors are configured to: direct the video stream to the video decoder; direct video output of the video decoder to the stream synchronizer; based on association of the at least one audio stream with the no volume condition, prevent transmission of the at least one audio stream to the at least one audio decoder; and provide synchronized stream output from the stream synchronizer to one or more output devices.

Example 3 includes the device of Example 2, wherein the one or more processors are further configured to turn off the at least one audio decoder based on a duration of the no volume condition exceeding a threshold duration.

Example 4 includes the device of Example 2 or 3, wherein the one or more processors are further configured to: obtain input that indicates a change from the no volume condition to a volume condition; and based on the input: turn on the at least one audio decoder based on a determination that the at least one audio decoder is turned off; provide the at least one audio stream to the at least one audio decoder; and provide audio output from the at least one audio decoder to the stream synchronizer.

Example 5 includes the device of Example 4, wherein the stream synchronizer synchronizes the video output and the audio output based on a system clock.

Example 6 includes the device of any of Examples 2 to 5, further comprising a stream de-multiplexer configured to receive the media stream and output the video stream to a video path and output the at least one audio stream to an audio path.

Example 7 includes the device of any of Examples 2 to 6, wherein the one or more output devices include one or more speakers, one or more display devices, or both.

Example 8 includes the device of any of Examples 1 to 7, further comprising a video encoder, at least one audio encoder, and a controller, wherein the one or more processors obtain the media stream from an audio/video recording application, wherein the media stream further includes a video stream, and wherein the one or more processors are further configured to: direct the video stream to the video encoder; provide encoded video frames of the video stream from the video encoder to the controller; based on association of the at least one audio stream with the no volume condition, prevent transmission of the at least one audio stream to the at least one audio encoder; and store output from the controller to a file.

Example 9 includes the device of Example 8, wherein the one or more processors are further configured to turn off the at least one audio encoder based on a duration of the no volume condition exceeding a threshold duration.

Example 10 includes the device of Example 8 or Example 9, wherein the one or more processors are further configured to: obtain input that indicates a change from the no volume condition to a volume condition; and based on the input: turn on the at least one audio encoder based on a determination that the at least one audio encoder is turned off; provide the at least one audio stream to the at least one audio encoder; and provide encoded audio frames to the controller.

Example 11 includes the device of any of Example 8 to Example 10, further comprising a stream de-multiplexer configured to receive the media stream and output the video stream to a video decoder.

Example 12 includes the device of any of Example 1 to Example 11, further comprising at least one audio decoder, wherein the one or more processors obtain the media stream from an audio application, and wherein the one or more processors are further configured to, based on association of the at least one audio stream with the no volume condition, prevent transmission of the at least one audio stream to the at least one audio decoder.

Example 13 includes the device of Example 12, wherein the one or more processors are further configured to turn off the at least one audio decoder based on a duration of the no volume condition exceeding a threshold duration.

Example 14 includes the device of Example 13, wherein the one or more processors are configured to enable transition to a low power state based on the duration of the no volume condition exceeding a second threshold duration.

Example 15 includes the device of any of Example 12 to Example 14, wherein the one or more processors are further configured to: obtain input that indicates a change from the no volume condition to a volume condition; and based on the input: turn on the at least one audio decoder based on a determination that the at least one audio decoder is turned off; provide the at least one audio stream to the at least one audio decoder; and provide decoded audio frames to one or more output devices.

Example 16 includes the device of any of Example 1 to Example 15, wherein the no volume condition is determined based on a volume level setting.

Example 17 includes the device of Example 16, wherein the volume level setting is a default volume or a volume set by user activation of one or more volume controls.

Example 18 includes the device of Example 16, wherein the volume level setting is set by user selection of a particular volume via a graphic user interface.

Example 19 includes the device of any of Example 1 to Example 18, wherein the no volume condition is determined based on a volume on/off setting.

Example 20 includes the device of Example 19, wherein the volume on/off setting indicates the no volume condition when the device is in a mute mode.

Example 21 includes the device of any of Example 1 to Example 20, wherein the no volume condition is determined based on an analysis of audio stream content.

Example 22 includes the device of any of Example 1 to Example 21, further comprising a modem coupled to the one or more processors, the modem configured to transmit content produced from the media stream to a second device.

Example 23 includes the device of any of Example 1 to Example 22, wherein the one or more processors are integrated in a headset device powered by a rechargeable battery, and wherein disablement of the audio coding based on the no volume condition during use of the headset device extends a use time of the headset device between charges of the rechargeable battery when one or more no volume conditions occur during use of the headset device.

Example 24 includes the device of any of Example 1 to Example 22, wherein the one or more processors are integrated in at least one of a mobile phone, a tablet computer device, a wearable electronic device, a camera device, a virtual reality headset, a mixed reality headset, or an augmented reality headset.

Example 25 includes the device of any of Example 1 to Example 22, wherein the one or more processors are integrated in a vehicle.

According to Example 26, a method comprises: obtaining, at one or more processors, a media stream that includes at least one audio stream; and disabling, via the one or more processors, audio coding of the at least one audio stream based on a no volume condition associated with the at least one audio stream.

Example 27 includes the method of Example 26, wherein the disabling the audio coding includes, based on association of the at least one audio stream with the no volume condition, preventing, via the one or more processors, transmission of the at least one audio stream to one or more audio decoders.

Example 28 includes the method of Example 26 or Example 27, wherein the disabling of the audio coding includes, based on association of the at least one audio stream with the no volume condition, preventing, via the one or more processors, transmission of the at least one audio stream to one or more audio encoders.

According to Example 29, a device includes: a memory configured to store instructions; and a processor configured to execute the instructions to perform the method of any of Example 26 to Example 28.

According to Example 30, a non-transitory computer-readable medium stores instructions that, when executed by a processor, cause the processor to perform the method of any of Example 26 to Example 28.

According to Example 31, an apparatus includes means for carrying out the method of any of Example 26 to Example 28.

According to Example 32, a non-transitory computer-readable medium comprises instructions that, when executed by one or more processors, cause the one or more processors to: obtain a media stream that includes at least one audio stream; and disable audio coding of the at least one audio stream based on a no volume condition associated with the at least one audio stream.

According to Example 33, an apparatus comprises means for obtaining a media stream that includes at least one audio stream; and means for disabling audio coding of the at least one audio stream based on a no volume condition associated with the at least one audio stream.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
obtain a media stream that includes at least one audio stream; and
disable audio coding of the at least one audio stream based on a no volume condition associated with the at least one audio stream.

2. The device of claim 1, further comprising a video decoder, at least one audio decoder, and a stream synchronizer, wherein the media stream further includes a video stream, and wherein the one or more processors are configured to:
direct the video stream to the video decoder;
direct video output of the video decoder to the stream synchronizer;
based on association of the at least one audio stream with the no volume condition, prevent transmission of the at least one audio stream to the at least one audio decoder; and
provide synchronized stream output from the stream synchronizer to one or more output devices.

3. The device of claim 2, wherein the one or more processors are further configured to turn off the at least one audio decoder based on a duration of the no volume condition exceeding a threshold duration.

4. The device of claim 2, wherein the one or more processors are further configured to:
obtain input that indicates a change from the no volume condition to a volume condition; and
based on the input:
turn on the at least one audio decoder based on a determination that the at least one audio decoder is turned off;
provide the at least one audio stream to the at least one audio decoder; and
provide audio output from the at least one audio decoder to the stream synchronizer.

5. The device of claim 4, wherein the stream synchronizer synchronizes the video output and the audio output based on a system clock.

6. The device of claim 2, further comprising a stream de-multiplexer configured to receive the media stream and output the video stream to a video path and output the at least one audio stream to an audio path.

7. The device of claim 2, wherein the one or more output devices include one or more speakers, one or more display devices, or both.

8. The device of claim 1, further comprising a video encoder, at least one audio encoder, and a controller, wherein the one or more processors obtain the media stream from an audio/video recording application, wherein the media stream further includes a video stream, and wherein the one or more processors are further configured to:
direct the video stream to the video encoder;
provide encoded video frames of the video stream from the video encoder to the controller;
based on association of the at least one audio stream with the no volume condition, prevent transmission of the at least one audio stream to the at least one audio encoder; and
store output from the controller to a file.

9. The device of claim 8, wherein the one or more processors are further configured to turn off the at least one audio encoder based on a duration of the no volume condition exceeding a threshold duration.

10. The device of claim 8, wherein the one or more processors are further configured to:
obtain input that indicates a change from the no volume condition to a volume condition; and
based on the input:
turn on the at least one audio encoder based on a determination that the at least one audio encoder is turned off;
provide the at least one audio stream to the at least one audio encoder; and
provide encoded audio frames to the controller.

11. The device of claim 8, further comprising a stream de-multiplexer configured to receive the media stream and output the video stream to a video decoder.

12. The device of claim 1, further comprising at least one audio decoder, wherein the one or more processors obtain the media stream from an audio application, and wherein the one or more processors are further configured to, based on association of the at least one audio stream with the no volume condition, prevent transmission of the at least one audio stream to the at least one audio decoder.

13. The device of claim 12, wherein the one or more processors are further configured to turn off the at least one audio decoder based on a duration of the no volume condition exceeding a threshold duration.

14. The device of claim 13, wherein the one or more processors are configured to enable transition to a low power state based on the duration of the no volume condition exceeding a second threshold duration.

15. The device of claim 12, wherein the one or more processors are further configured to:
obtain input that indicates a change from the no volume condition to a volume condition; and
based on the input:
turn on the at least one audio decoder based on a determination that the at least one audio decoder is turned off;
provide the at least one audio stream to the at least one audio decoder; and
provide decoded audio frames to one or more output devices.

16. The device of claim 1, wherein the no volume condition is determined based on a volume level setting.

17. The device of claim 16, wherein the volume level setting is a default volume or a volume set by user activation of one or more volume controls.

18. The device of claim 16, wherein the volume level setting is set by user selection of a particular volume via a graphic user interface.

19. The device of claim 1, wherein the no volume condition is determined based on a volume on/off setting.

20. The device of claim 19, wherein the volume on/off setting indicates the no volume condition when the device is in a mute mode.

21. The device of claim 1, wherein the no volume condition is determined based on an analysis of audio stream content.

22. The device of claim 1, further comprising a modem coupled to the one or more processors, the modem configured to transmit content produced from the media stream to a second device.

23. The device of claim 1, wherein the one or more processors are integrated in a headset device powered by a rechargeable battery, and wherein disablement of the audio coding based on the no volume condition during use of the headset device extends a use time of the headset device between charges of the rechargeable battery when one or more no volume conditions occur during use of the headset device.

24. The device of claim 1, wherein the one or more processors are integrated in at least one of a mobile phone, a tablet computer device, a wearable electronic device, a camera device, a virtual reality headset, a mixed reality headset, or an augmented reality headset.

25. The device of claim 1, wherein the one or more processors are integrated in a vehicle.

26. A method comprising:
obtaining, at one or more processors, a media stream that includes at least one audio stream; and
disabling, via the one or more processors, audio coding of the at least one audio stream based on a no volume condition associated with the at least one audio stream.

27. The method of claim 26, wherein the disabling the audio coding includes, based on association of the at least one audio stream with the no volume condition, preventing, via the one or more processors, transmission of the at least one audio stream to one or more audio decoders.

28. The method of claim 26, wherein the disabling of the audio coding includes, based on association of the at least one audio stream with the no volume condition, preventing, via the one or more processors, transmission of the at least one audio stream to one or more audio encoders.

29. A non-transitory computer-readable medium comprising instructions that, when executed by one or more processors, cause the one or more processors to:
obtain a media stream that includes at least one audio stream; and
disable audio coding of the at least one audio stream based on a no volume condition associated with the at least one audio stream.

30. An apparatus comprising:
means for obtaining a media stream that includes at least one audio stream; and
means for disabling audio coding of the at least one audio stream based on a no volume condition associated with the at least one audio stream.
